(19) United States
(12) Patent Application Publication
(10) Pub. No.: US 2005/0041936 A1
(43) Pub. Date: Feb. 24, 2005

(54) Optical interconnection module

(75) Inventors: Gilles Billet, Voiron (FR); Jean-Michel Burry, Hauteville-Lompnes (FR)

Correspondence Address: OLIFF & BERRIDGE, PLC, P.O. BOX 19928, ALEXANDRIA, VA, 22320, US

(73) Assignees: IFOTEC, Voiron (FR); Optique et Microsystemes SA, Montreal La Cluse (FR)

(21) Appl. No.: 10/496,977

(22) PCT Filed: Dec. 10, 2002
(86) PCT No.: PCT/FR02/04246

(30) Foreign Application Priority Data
Dec. 10, 2001 (FR) 01/15940

(51) Int. Cl. G02B 6/36

(52) U.S. Cl. 385/93

(57) ABSTRACT

The optical interconnection module (1) between a fiber (2) and an electro-optical component (3) comprises a body (5) made of transparent plastic material, wherein one end of the fiber is held. The component (3) is arranged at least partially in a cavity (6) of the module. Positioning of the end of the fiber with respect to the component is performed by plastic deformation of the body (5) of the module caused by localized heating of the body (5). The heated part of the body can be formed by a thin annular wall bounding, at the top part of a non-deformable central part of the body, the cavity wherein the electro-optical component (3) is positioned. An insert (7) made of ferromagnetic material arranged in an intermediate zone of the body of the module, between the end of the fiber and the electro-optical component, can also enable deformation of the body (5) when heated by induction.

### BACKGROUND OF THE INVENTION

The invention relates to an optical interconnection module between an optical fiber and at least one electro-optical component, module comprising a body made of transparent plastic material, wherein one end of the fiber is held, and means for positioning the end of the fiber with respect to the component arranged at least partially in a cavity of the module.

### STATE OF THE ART

The cost of an optical fiber transmission network depends to a large extent on the cost of the connections between the optic fibers and light-emitting or light-receiving electro-optical components. In the prior art, an optical fiber is fixed onto a connector and the electro-optical component to be connected, for example a laser diode, is moved laterally and possibly longitudinally with respect to the connector, so as to be aligned with the end of the fiber, before being stuck onto the connector. Such an alignment process is long and consequently costly.

### OBJECT OF THE INVENTION

The object of the invention is to reduce the cost of interconnection between an optical fiber and at least one electro-optical component.

According to the invention, this object is achieved by a module according to the appended claims and more particularly by a module wherein the positioning means comprise means for plastic deformation of the body of the module.

An interconnection module is thus obtained enabling a very precise positioning, and more particularly an alignment, of the end of an optical fiber and of an electro-optical component to be easily achieved.

A duplexer can be formed from a module comprising three branches arranged substantially in a Y shape or in a T shape.

### BRIEF DESCRIPTION OF THE DRAWINGS

Other advantages and features will become more clearly apparent from the following description of particular embodiments of the invention given as non-restrictive examples only and represented in the accompanying drawings, in which:

FIGS. 1 to 5, 8 and 9 represent, in cross-section, different embodiments of an inter-connection module according to the invention.

FIG. 6 illustrates alignment of the end of a fiber and of a component with a module according to FIG. 2.

FIGS. 7 to 10 represent two particular embodiments of a duplexer.

### DESCRIPTION OF A PARTICULAR EMBODIMENTS

An optical interconnection module 1 is designed to connect an optical fiber 2 and an electro-optical emitting (laser diode for example) or receiving (detector for example) component 3. The component 3 can for example be constituted by an off-the-shelf encapsulated component equipped with an electrical cable 4, for example of coaxial type.

The optical interconnection module 1 constitutes an optical microsystem with a diameter of about 1 cm for a length of about 15 mm. It comprises a body 5 made of plastic material, transparent at the wavelengths to be transmitted, for example in the infrared and the visible. One end of the optical fiber 2 is secured in the body 5, the refractive index whereof is preferably of the same order of magnitude as that of the fiber, typically comprised between 1.45 and 1.47. In a preferred embodiment, the end of the optical fiber 2 is moulded from a casting in the plastic body 5, which enables a connector between the fiber and the module 1 to be eliminated and the cost of interconnection to be substantially reduced. Moulding the end of the optical fiber in the body 5 from a casting enables a good optical continuity to be achieved and eliminates stray reflections at the output of the fiber.

To optimize coupling between the optical fiber 2 and component 3, the latter have to be positioned with precision with respect to one another. According to the invention, a precise positioning, more particularly an alignment, is made possible by plastic deformation of the body 5.

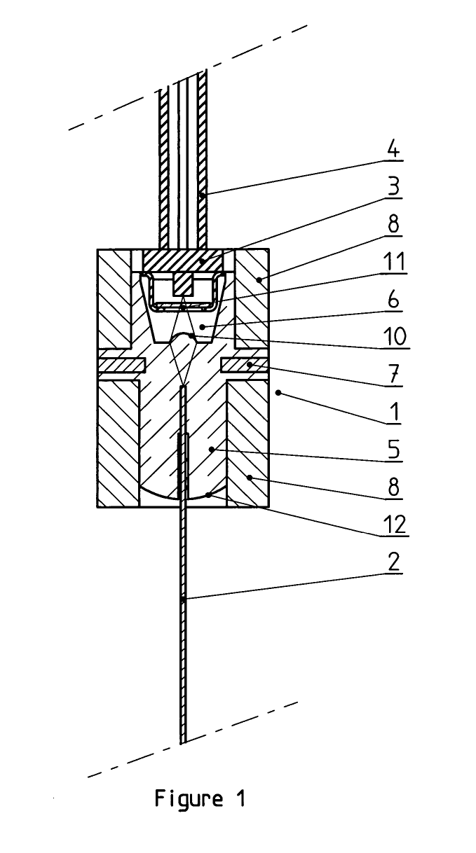

In the particular embodiments of FIGS. 1 to 8, the electro-optical component 3 is fixed, by any suitable means, for example by sticking or crimping, in a cavity 6 of the module. An insert 7, made of ferromagnetic material, is arranged in an intermediate zone of the body 5, which is situated between the end of the fiber 2 and the component 3. The insert 7 is preferably formed by an annular ring made of iron, nickel or iron and nickel alloy. The plasticity of the body 5 is such that heating the insert 7, for example by induction, and therefore without contact, enables the body 5 to be deformed by creeping of the plastic material so as to align the end of the fiber 2 and the component 3 very exactly, the body subsequently keeping the chosen position after cooling. Thus, the relative movements between the optical fiber 2 and the component 3 are made possible by a phase change (local melting) of the plastic body caused by local heating of the insert 7. Fixing of the relative position between the fiber 2 and the component 3 is achieved by resolidification of the plastic body.

For ease of handling of the parts of the body 5 situated on each side of the insert 7 independently from one another, the module 1 preferably comprises support elements 8 made of non-magnetic material arranged at the periphery of the body of the module on each side of the insert 7. The support elements 8 are preferably made of stainless steel, aluminium or ceramic, non-magnetic materials that are therefore not heated by induction. The support elements can moreover act as cooling elements.

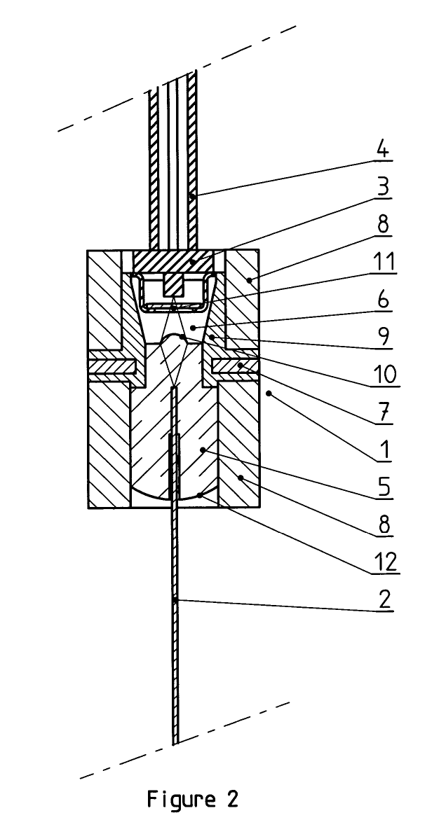

In a particular embodiment, represented in FIG. 2, the body 5 is formed from two plastic materials having different melting temperatures. It thus comprises, in the intermediate zone in which the insert 7 is located, a part 9 forming a hinge formed by a second plastic material having a lower melting temperature than the melting temperature of the plastic material forming the rest of the body. The plastic materials forming the body 5 are chosen in such a way that their melting temperatures are such that heating by induction of the insert 7 during a preset period enables a sufficient plasticity to be obtained in the intermediate zone of the body 5. The body 2 can for example be formed by injection. The body 5 (FIG. 1) or the part 9 only (FIG. 2) can for example be formed by polycarbonate or polysulfone.

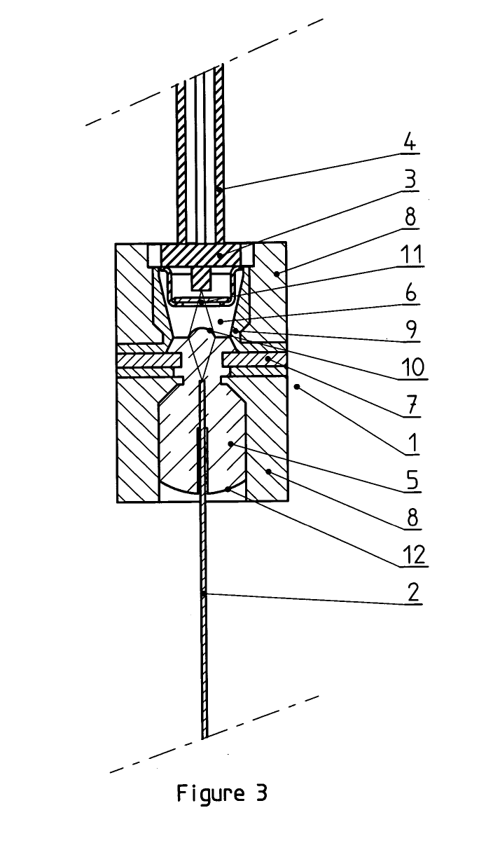

In FIGS. 1 and 2, the support elements 8 are cylindrical. The shape of their internal walls, in contact with the body 5, can be modified, for example in the manner represented in FIG. 3, to take account of the heat diffusion from the insert 7. In the particular embodiment of FIG. 3, the support elements 8 thus comprise an inwardly salient part at their end situated in proximity to the insert 7. The particular shape chosen can be determined from thermal modelling of the module.

The module of FIG. 3 is also distinguished from the module of FIG. 2 by the shape of the part 9 of the body 5 forming a hinge. Indeed, in FIG. 2, the part 9 encompasses the whole of the insert 7 whereas the insert 7 is slightly salient from the part 9 of the module of FIG. 3.

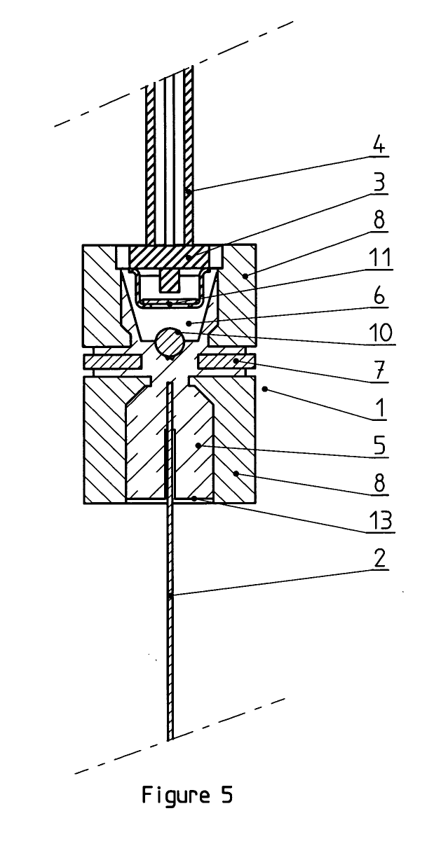

A lens 10 is preferably arranged between the end of the optical fiber 2 and the component 3. It is designed to concentrate a light beam emitted by a component 3 of emitter type on the end of the fiber 2 or, reciprocally, to concentrate a light beam transmitted by the fiber 2 onto a component 3 of receiver type (see FIG. 1). The lens is preferably (FIGS. 1 to 4 and 9) formed by a convex protuberance of the body 5 forming a spherical or aspherical zone facing the moulded end of the fiber 2. A ring-shaped lens presents the advantage of enabling a possible astigmatism of the component 3 to be corrected. The lens 10 can also be formed by a diopter moulded from casting in the body 5 or, as represented in FIG. 5, by a glass ball clipped into a suitable cavity formed in the body 5. In the latter case, the end of the fiber 2 can be closer to the lens 10. In certain cases, the component 3 can already comprise a lens, for example on the window 11 of a laser diode, and the lens 10 is then not indispensable. The lens 10 can however, if required, be formed by an assembly of several lenses. The lens 10 can also be formed by a holographic lens moulded or replicated in the body 5.

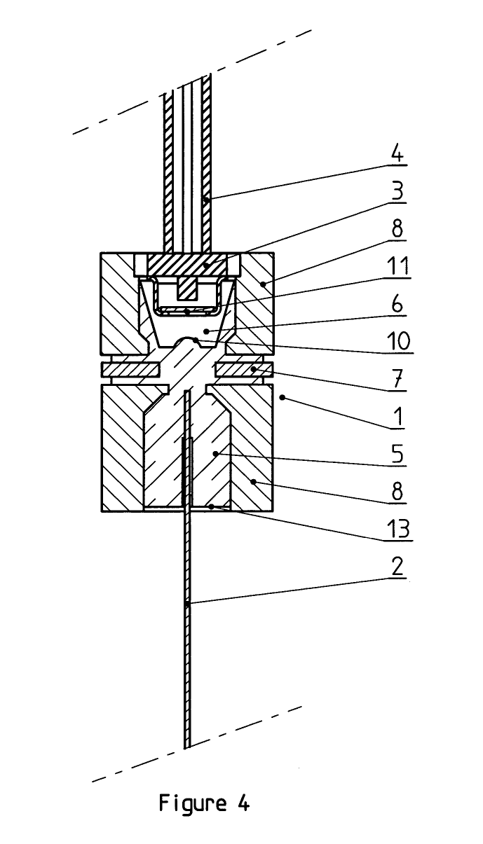

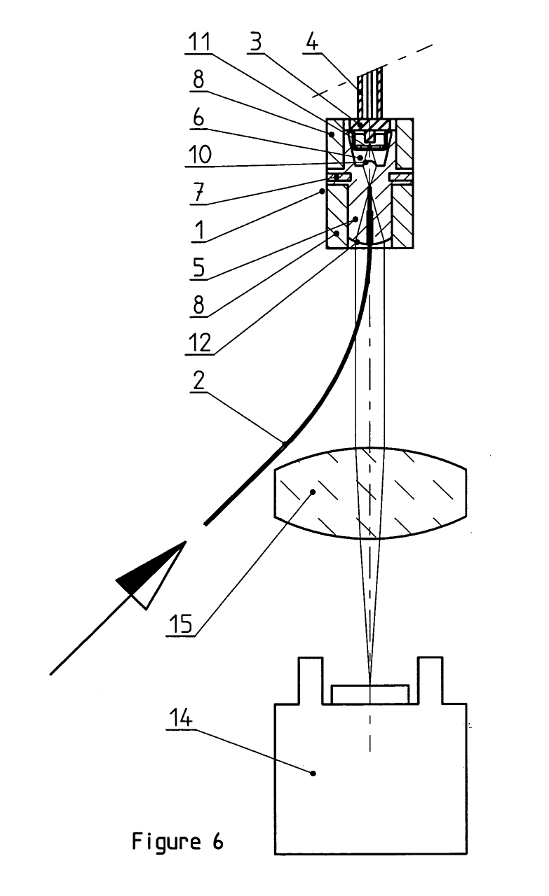

The body 5 comprises an optical surface, at its end that is situated opposite the component 3 and via which the fiber 2 is inserted in the module, enabling the component to be visualized during positioning thereof with respect to the end of the optical fiber 2. In FIGS. 1 to 3 and 6, this surface is a convex optical surface 12 whereas in FIGS. 4, 5 and 9, it is a flat optical surface 13. It could also be concave or prismatic. The function of the optical surface 12 during alignment is illustrated in greater detail in FIG. 6, in which the module is of the type represented in FIG. 2. During the alignment operation, a light beam (represented by an arrow in FIG. 6) is sent into the fiber 2 via the free end thereof. The light beam transmitted by the fiber 2 is concentrated on the component 3 by the lens 10 of the transparent plastic body 5. A camera 14 is arranged in such a way as to simultaneously visualize, by means of an objective 15, the image of the component 3 and the light beam coming from the fiber, which forms a patch or a light spot at the level of the component 3. The insert 7 is then heated by induction and the body 5 deformed so as to align the light spot on the image of the component 3. A very precise alignment of the end of the fiber 2 and of the component 3 is thus obtained.

It is also possible to achieve automatic alignment, in particular in the case where the component 3 is an emitter, for example a laser diode. The support elements 8 situated on the same side as the fiber with respect to the insert 7 (in the bottom part in FIGS. 1 to 6) can be kept in a fixed position, whereas the support elements 8 situated on the same side as the component with respect to the insert (in the top part in FIGS. 1 to 6) can be moved by means, not represented, controlled by the error detected between the position of the end of the fiber and the position of the light beam emitted by the laser diode.

The module described above can be used for interconnection of an optical fiber 2 with any electro-optical component 3, whether the latter constitutes an emitter or a receiver. It is possible to combine several modules, possibly adapted, to form particular interconnections between several components. In all cases, connection of the fiber and electro-optical component by means of a microsystem made of plastic material enables a large volume of interconnections to be fabricated at low cost. The invention can also be used in a module with several branches designed to form a duplexer, a triplexer, a quadriplexer, etc. Each branch then comprises independent means for plastic deformation.

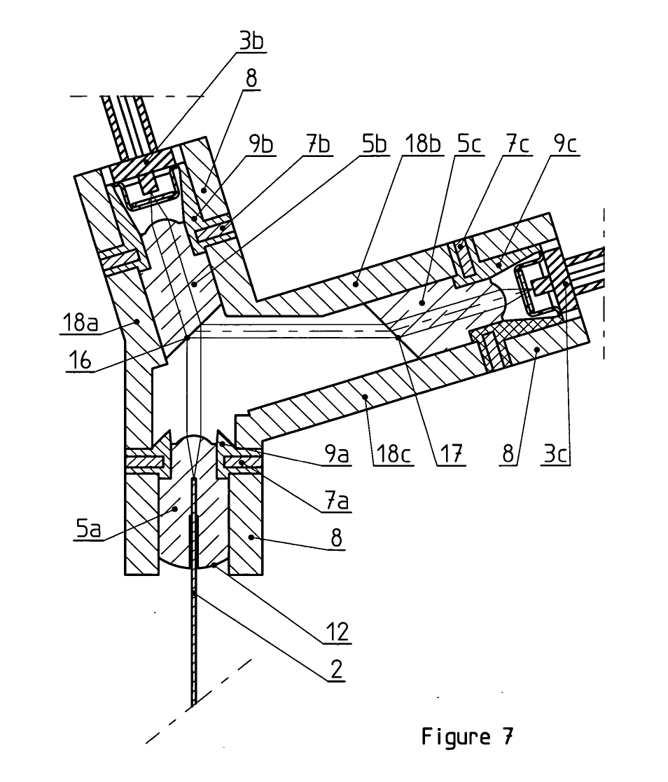

For example purposes, FIG. 7 illustrates a duplexer formed by a module with three branches arranged substantially in a Y shape. A first branch comprises a first body 5a made of plastic material in which the end of the fiber 2 is held. A second branch comprises a second body 5b made of plastic material with a dichroic-treated input face 16 that is flat and inclined with respect to the axis of the end of the fiber 2. A light-receiving electro-optical component 3b is arranged at the free end of the second branch. A third branch comprises a third body 5c made of plastic material with an output face 17 inclined with respect to the input face 16 of the second body 5b made of plastic material and to the axis of the end of the fiber 2. A light-emitting electro-optical component 3c is arranged at the free end of the third branch. The bodies of two adjacent branches are joined by common support elements made of non-magnetic material. Thus a support element 18a is common to the bodies 5a and 5b, a support element 18b is common to the bodies 5b and 5c and a support element 18c is common to the bodies 5c and 5a. Each plastic body 5a, 5b and 5c comprises independent means for plastic deformation (inserts 7a, 7b and 7c and preferably parts 9a, 9b and 9c forming hinges). The receiving component 3b can thus receive a light beam coming from the emitting component 3c. Precise positioning of the end of the fiber and of the receiving component 3b and emitting component 3c is achieved by suitable plastic deformation of the bodies 5a, 5b and 5c by means of the associated inserts 7a, 7b and 7c.

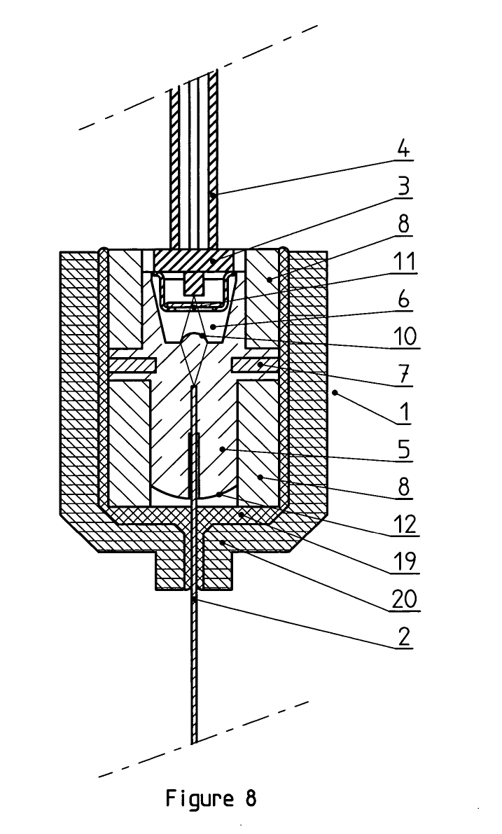

In FIG. 8, a protective sheath 20 is attached for example by means of a glue 19 to a module of the same type as in FIG. 1. The module is thus encapsulated in the sheath 20 which can be formed by a rigid shell, for example made of metal.

This encapsulation is designed to ensure that the elements are kept in the chosen position over time and consequently to preserve the performances of the optical coupling. This can be of interest in particular in applications requiring a very precise alignment or in environments involving stresses of mechanical, climatic, etc. nature. The sheath 20 can be made from a material enabling expansions to be controlled, or from a shape-memory material.

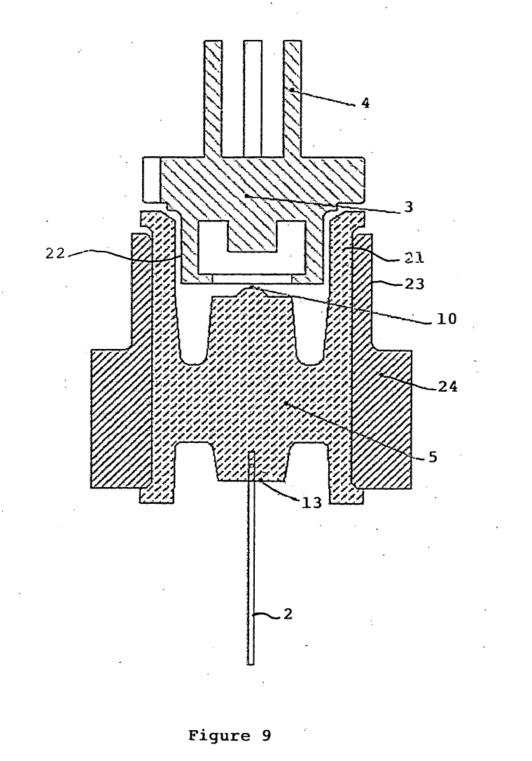

FIG. 9 illustrates another embodiment of an interconnection module according to the invention. In this embodiment, the body 5 made of transparent plastic material comprises an non-deformable central part constituting an optical part, and a deformable part not used for transmission of the optical signals between the optical fiber 2 and the electro-optical component 3 but acting as support for the electro-optical component 3. In FIG. 9, the deformable part of the body 5 is formed by a thin annular wall 21 bounding, at the top part of the body, a cavity 22 wherein the electro-optical component 3 is positioned. Plastic deformation of the annular wall 21 of the body 5 is obtained by heating of the annular wall 21.

In the particular embodiment illustrated in FIG. 9, localized heating of the annular wall 21 can be achieved by conduction by means of a deformable upper part 23 of an annular external element 24 forming a ring or a tube in contact with the side wall of the body 5. The deformable upper part 23 surrounds the annular part 21 of the body 5. The annular external element 24 is preferably formed by a stainless steel tube wherein the body 5 is moulded and its deformable upper part 23 can be heated by Joule effect by a thermal heating clamp with which it is placed in contact.

To align the electro-optical component 3 and the fiber 2, the component 3 is moved towards the cavity 22 of the body 5 of the module and partially inserted in this cavity. The deformable upper part 23 is heated locally, for example by means of a heat clamp (not shown), thus heating the annular wall 21 of the body 5 by conduction, which wall can then be deformed. The component 3 is then positioned so as to optimize its optical coupling with the optical fiber 2. In a preferred embodiment, the position of the component 3 in the cavity 22 is then fixed by a mechanical deformation of the annular wall 21. This mechanical deformation can be performed by any suitable means, for example by a few spikes (three or four, for example) salient towards the inside of the heat clamp, so as to mechanically deform the deformable upper part 23 and the annular wall 21 locally, in stamping or crimping manner. The assembly is then cooled to the ambient temperature, thus keeping an optimized coupling.

To protect the non-deformable central part forming the optical part of the body 5 while the annular part 21 is heated, it may be desirable to cool this part of the body. In the embodiment represented in FIG. 9, the annular external element 24 comprises a broader annular base surrounding the non-deformable central part of the body 5. This annular base is cooled during alignment of the electro-optical component 3, for example by conduction by means of a second heat clamp (not shown) surrounding the base of the annular element 24 and acting as energy extractor. The dimensions and respective positions of the different parts of the annular external element 24 and of the body 5 and the temperatures of the heat clamps are chosen such as to allow a localized deformation of the annular part 21 without the rest of the body 5 being deformed. For example, the annular part can be heated to a temperature close to 260° C. whereas the central part of the body 5 is kept at a temperature preventing any deformation, for example at a temperature close to the ambient temperature.

Localized heating of the annular part 21 can be performed either directly or by means of the deformable upper part 23 by any suitable means, for example by laser.

The end of the optical fiber 2 is preferably moulded from casting in the body 5. However, the invention is not limited to this particular embodiment and applies whatever the manner in which the end of the optical fiber 2 is rendered secure to the body 5. The end of the optical fiber 2 can for example be stuck or fixed to the body 5 in removable manner, by means of a standard connector. In this case, alignment of the electro-optical component 3 and the end of the fiber 2 is achieved as described above after the standard connector has been fitted and the optical fiber has been connected to the standard connector.

The module of FIG. 9 can be used for interconnection of an optical fiber 2 with any electro-optical component 3, whether the latter constitutes an emitter or a receiver. It is possible to combine several modules, possibly adapted, to form particular interconnections between several components or to form a duplexer, a triplexer, a quadriplexer, etc. . . . , each branch whereof comprises independent means for plastic deformation.

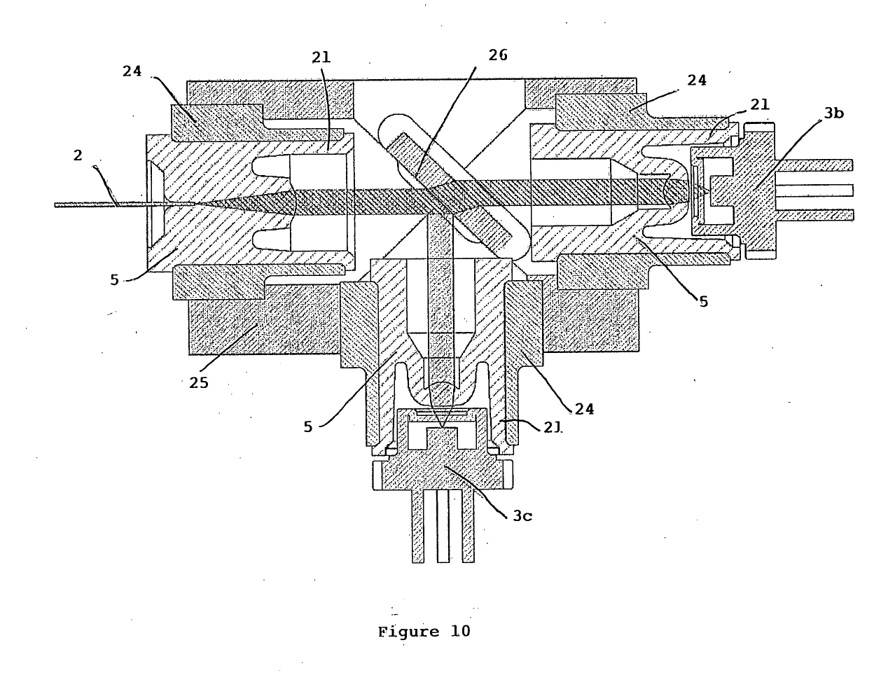

For example purposes, FIG. 10 illustrates a duplexer with three branches arranged substantially in the form of a T. A first branch (on the left in FIG. 10) comprises a first body 5 made of plastic material wherein the end of the fiber 2 is secured and which is equipped with an annular external element 24. A second branch arranged as a continuation of the first branch (on the right in FIG. 10) comprises a second body 5 made of plastic material bearing an electro-optical component 3b constituting a light receiver at the free end of the second branch. A third branch, perpendicular to the first and second branches, comprises a third body 5 made of plastic material bearing an electro-optical component 3c constituting a light emitter at the free end of the third branch.

The three bodies 5 are fixed in a common casing 25 by means of the broader bases of their annular external elements 24. A semi-reflecting blade 26 is arranged in a free space situated between the first and second bodies 5, above the third body 5, in a preferred embodiment at 45° with respect to the longitudinal axes of the bodies 5, so as to reflect a light signal emitted by the emitter (component 3c) to the fiber and to transmit a light signal originating from the fiber 2 to the receiver (component 3b). The blade 26 is fixed, for example by sticking or soldering, onto a support enabling it to be positioned precisely in the casing 25.

After the blade 26 and the three bodies 5 equipped with their annular external elements 24 have been assembled in the casing 25, the electro-optical components 3b and 3c are successively arranged in the associated bodies 5 and positioned by deformation of the annular wall 21 of the corresponding body 5 so as to optimize coupling thereof with the end of the fiber.

The components 3b and 3c respectively constituting the receiver and the emitter can be inverted and the emitter or the receiver can be replaced if required by an input or output fiber.

1. An optical interconnection module between an optical fiber and at least one electro-optical component, module comprising a body made of transparent plastic material, wherein one end of the fiber is held, and means for positioning the end of the fiber with respect to the component arranged at least partially in a cavity of the module, the positioning means comprising means for plastic deformation of the body (5) of the module (1).

2. Module according to claim 1, wherein the body comprises a non-deformable central part and a thin annular wall bounding, at the top part of the body, the cavity wherein the electro-optical component is positioned, the means for plastic deformation of the body comprising means for localized heating of the annular wall.

3. Module according to claim 2, wherein the thin annular wall is in contact with a deformable part of an annular external element surrounding the body.

4. Module according to claim 1, wherein the means for deformation comprise an insert made of ferromagnetic material arranged in an intermediate zone of the body of the module, between the end of the fiber and the electro-optical component.

5. Module according to claim 4, wherein the insert is formed by a ring.

6. Module according to claim 4, wherein the body of the module comprises, in the intermediate zone, a part forming a hinge constituted by a second plastic material having a lower melting temperature than the melting temperature of the plastic material constituting the rest of the body.

7. Module according to claim 4 comprises comprising support elements made of non-magnetic material, arranged at the periphery of the body of the module, on each side of the insert.

8. Module according to claim 1, comprising a lens between the end of the optical fiber and the electro-optical component.

9. Module according to claim 8, wherein the lens is formed by a spherical, aspherical or holographical zone of the plastic body.

10. Module according to claim 8, wherein the lens is formed by a diopter moulded from casting in the plastic body.

11. Module according to claim 1 wherein the end of the optical fiber is moulded from casting in the plastic body.

12. Module according to claim 1 wherein the plastic body comprises an optical surface at its end via which the fiber is inserted in the module.

13. Module according to claim 1 comprising a protective sheath.

14. Module according to claim 1 comprising several branches each comprising independent means for plastic deformation.

15. Module according to claim 14, comprising three branches arranged substantially in a Y shape, a first branch comprising a first body made of plastic material in which the end of the fiber is held, a second branch comprising a second body made of plastic material with an input face inclined with respect to the axis of the end of the fiber, and a light-receiving electro-optical component arranged at the free end of the second branch, and a third branch comprising a third body made of plastic material with an output face inclined with respect to the input face of the second body made of plastic material and to the axis of the end of the fiber, a light-emitting electro-optical component being arranged at the free end of the third branch so as to form a duplexer, each plastic body comprising independent means for plastic deformation.

16. Module according to claim 15, wherein the bodies of two adjacent branches are connected by common support elements made of non-magnetic material.

17. Module according to claim 14, comprising three branches arranged substantially in a T shape and each comprising a body and a semi-reflecting blade arranged in a free space situated between the bodies of the three branches at 45° with respect to the longitudinal axes of the bodies.
